(19) United States
(12) Patent Application Publication
(10) Pub. No.: US 2014/0063369 A1
(43) Pub. Date: Mar. 6, 2014

(54) TOUCH DISPLAY

(71) Applicants: SHOEI CO., LTD., Gunma (JP); CALSONIC KANSEI CORPORATION, Saitama (JP)

(72) Inventors: Toshihiro HOSOROGIYA, Saitama-shi (JP); Tokuji YASUKAWA, Saitama-shi (JP); Masaru KURIBARA, Saitama-shi (JP); Toru OKIDATE, Saitama-shi (JP); Daisuke KONDOU, Saitama-shi (JP); Yoshikane TANAAMI, Isesaki-shi (JP); Tatsuya HANADA, Isesaki-shi (JP)

(73) Assignees: SHOEI CO., LTD., Gunma (JP); CALSONIC KANSEI CORPORATION, Saitama (JP)

(21) Appl. No.: 14/012,137

(22) Filed: Aug. 28, 2013

(30) Foreign Application Priority Data
Sep. 6, 2012 (JP) 2012-195913

(51) Int. Cl. G02F 1/1333

(52) U.S. Cl. CPC G02F 1/13338
USPC 349/12

(57) ABSTRACT

A touch display including a liquid crystal display having a surface displaying images and a capacitive touch-sensitive panel superposed on a surface of the liquid crystal display and enabling an input operation in reaction to the displayed image; wherein being arranged on the liquid crystal display in order from the surface of the liquid crystal display toward an outer surface of the liquid crystal display, a second quarter-wave plate converting a light passing through into a circular polarization by shifting phase, the capacitive touch-sensitive panel, a first quarter-wave plate having a same orientation to the second quarter-wave plate, a polarizer converting the light passing through into a linear polarization, a decorated sheet protecting an upper surface of the capacitive touch-sensitive panel, and an antireflection layer preventing a surface-reflection of outside light, in order to obtain the antireflection effect while keeping costs low.

### CROSS-REFERENCE TO RELATED APPLICATIONS

The present application is based on and claims priority from Japanese Patent Application Number 2012-195913, filed on Sep. 6, 2012, the disclosure of which is hereby incorporated by reference herein in its entirety.

### BACKGROUND OF THE INVENTION

1. Field of the Invention

The present invention relates to a touch display.

2. Description of the Related Art

A vehicle such as an automobile has an instrument panel installed in at a front of an interior of the vehicle. One or more instrumental devices displaying information needed for a driver are installed at the driver side or at the midpoint of the driver side and the passenger side of the instrument panel. Moreover, one or more control panels to control an air-conditioner or an audio device are installed at the midpoint of the driver side and the passenger side of the instrument panel. Then, the instrumental devices and control panels which have a display device including a liquid crystal display have been developed.

Further, there are some display devices, so-called “touch display”, having the liquid crystal display and enabling to input operation by touching a screen with a fingertip and so on. Now, these touch displays are spreading rapidly and expected to be installed to many vehicles in future.

Some of these touch displays use a resistive touch-sensitive panel or a capacitive touch-sensitive panel.

Of them, the resistive touch-sensitive panel has a configuration in that two transparent conductive films are arranged one above the other at some interval by spacers, and senses touch operation from that upper and lower transparent films partly contact with each other. The touch display with the use of the resistive touch-sensitive panel is the most widespread touch display.

On the other hand, a capacitive touch-sensitive panel senses the variation of a capacitance when the fingertip and so on contact or came close to a screen. The capacitive touch-sensitive panel has a higher sensitivity than the resistive touch-sensitive panel since it does not use a pressure with touch operation. These capacitive touch-sensitive panels are expected to be widespread in future.

FIG. 9 illustrates a generally-configured capacitance touch display 1 wherein a capacitive touch-sensitive panel 4 is attached to a surface (outer surface) of a liquid crystal display 2, and a decorated sheet 3 is attached to the capacitive touch-sensitive panel 4

The decorated sheet 3 is directly attached to a surface (outer surface) of the capacitive touch-sensitive panel 4, and they are arranged at a position in a front side of the liquid crystal display 2 through a thin layer of air 5. Moreover, a polarizer 6 which forms a part of the liquid crystal display 2 is integrally arranged on the surface of the liquid crystal display 2 in advance.

In case of the generally-configured capacitance touch display 1 having a foregoing configuration, an outside light L is reflected at respective boundary planes between outside air and the decorated sheet 3, the decorated sheet 3 and the capacitive touch-sensitive panel 4, and the capacitive touch-sensitive panel 4 and the layer of air 5 (reflected light La, Lb and Lc).

A difference of reflectance is determined depending on a difference in refractive index at the boundary planes, a maximum reflection occurs at the boundary with air having a maximum refractive index.

Therefore, grater reflections (reflected light La, Lc) occur at the boundary plane between outside air and the decorated sheet 3, and the boundary plane between the capacitive touch-sensitive panel 4 and the layer of inside air 5, while smaller reflection (reflected light Lb) occurs at the boundary plane between the decorated sheet 3 and the capacitive touch-sensitive panel 4 (reflected light La, Lc>reflected light Lb).

The reflectance of the touch display 1 having the foregoing configuration is 8%˜9% and the reflection is outstanding.

When the touch display is installed to the vehicle such as an automobile, the touch display is often subjected to direct sunlight. Moreover, in many cases the touch display is fixed to the vehicle. Therefore, it is difficult to adjust the touch display to the easily viewable angle with less reflection.

Therefore, there is a need for the touch display having low reflectance with no need for angle adjustment to be installed to the vehicle. Previously, as an example of a touch display having low reflectance, a touch display with a resistive touch-sensitive panel such as in Japanese Patent Application Publication No. 2000-321558 (Patent Document 1) has been proposed.

That is to say, the touch display disclosed in Patent Document 1 decreases the reflectance by arranging to the liquid crystal display, in order from outside, a polarizer, a quarter-wave plate, a resistive touch-sensitive panel, a second quarter-wave plate, a plurality of decorated sheet having optical isotropy.

### SUMMARY OF THE INVENTION

However, the configuration of touch display disclosed in Patent Document 1 uses the resistive touch-sensitive panel. And, the resistive touch-sensitive panel has the configuration in that transparent conductive films are arranged one above the other at some interval by spacers, and a touch operation is sensed by a partial contact of upper and lower transparent films. Thus, there is a problem that the touch operation cannot be sensed accurately due to a reduction in sensitivity of the resistive touch-sensitive panel if a number of adhered or coating layers on the surface (outer surface) of the resistive touch-sensitive panel.

For this reason, the decorated sheet formed of a thick film must be attached to a reverse side of the resistive touch-sensitive panel instead of an obverse side thereof.

However, when the decorated sheet is attached to the reverse side of the resistive touch-sensitive panel, the decorated sheet made of the optically isotropic material which is expensive must be attached further inside of the second quarter-wave plate in order not to prevent effects of the polarizer and the quarter-wave plate to reduce the reflectance. In this way, there are problems of increase in cost and that the touch display cannot obtain enough decorating effect or protecting effect by the decorated sheet.

Moreover, there is a problem that the further increase in cost because the polarizer and the quarter-wave plate mentioned above are expensive material in itself, and required larger dimension than the dimension of the liquid crystal display and the resistive touch-sensitive panel when they used as the outer surface having a designed surface.

To solve the problems, the present invention aims to provide the touch display having a high antireflection structure while keeping costs low. Thus, the present invention is the touch display capable of input operation in reaction to a displayed image comprising a liquid crystal display displaying images and a capacitive touch-sensitive panel superposed on a surface of the liquid crystal display wherein a second quarter-wave plate converting a light passing through into a circular polarization by shifting phase, a capacitive touch-sensitive panel, a first quarter-wave plate having a same orientation to the second quarter-wave plate, a polarizer converting the light passing through into a linear polarization, a decorated sheet protecting an upper surface of the capacitive touch-sensitive panel; and an antireflection layer preventing a surface-reflection of an outside light are provided on the liquid crystal display in order from the surface of the liquid crystal display toward an outer surface of the liquid crystal display.

According to the present invention described in Claim 1, following function effect can be obtained by the configuration described above. That is to say, at first, most of the reflection of the outside light is minimized by the antireflection layer arranged at outermost. At that time, the reflection of the outside light is highest at the boundary with air. Therefore, the highest effect of antireflection is obtained by arranging the antireflection layer at the outermost part.

Then, a part of the outside light passing through the antireflection layer is reflected by each layer. Of them, the reflected light from an upper surface of the capacitive touch-sensitive panel and the reflected light from the rear surface of the capacitive touch-sensitive panel will be cut by the polarizer. As a result, the reflectance can be minimized to approximately 1% or less.

More particularly, the outside light passing through the decorated sheet is unpolarized light. And the outside light is converted into linearly-polarized light by passing through the polarizer. Further, the outside light, which is now linearly-polarized light, is converted into circularly-polarized light by passing through the first quarter-wave plate.

Then, a part of the outside light, which is the circularly-polarized light, is reflected at the surface of the capacitive touch-sensitive panel and converted into counter-rotating circularly-polarized light by phase-reversal. The reflected light, which is now the counter-rotating circularly-polarized light, is converted into the linearly-polarized light once again by passing through the first quarter-wave plate.

The reflected light, which is the linearly-polarized light, is perpendicular to the direction of polarization of the polarizer because of the reversed phase thereof and cut by the polarizer.

Moreover, the rest of the outside light passing through the first quarter-wave plate and became the circularly-polarized light is reflected at the rear surface of the second quarter-wave plate and converted into counter-rotating circularly-polarized light by phase-reversal. The reflected light, which is now the counter-rotating circularly-polarized light, is converted into the linearly-polarized light once again by passing through the capacitive touch-sensitive panel and the first quarter-wave plate.

In the same way, the reflected light, which is the linearly-polarized light, is perpendicular to the direction of polarization of the polarizer because of the reversed phase thereof and cut by the polarizer.

On the other hand, other polarizer is integrally attached to the surface of the liquid crystal display as a part of a configuration of the liquid crystal display in advance. An image from the liquid crystal display is converted into the linearly-polarized light by the polarizer. Then, the image, which is the linearly-polarized light, is converted into the circularly-polarized light by passing through the second quarter-wave plate, and further converted into the linearly-polarized light by passing through the capacitive touch-sensitive panel and the first quarter-wave plate. This linearly-polarized light can pass through the polarizer without problem by aligning its polarizing direction with polarizing axis of the polarizer. Therefore, the image from the liquid crystal display is visible externally through the decorated sheet and the antireflection layer.

More specifically, the decorated sheet can be arranged on the outer side of the capacitive touch-sensitive panel without a decrease in sensing performance by virtue of the fact that the capacitive touch-sensitive panel does not sense a pressure with touch operation. Then, arranging the decorated sheet to the outer side of the capacitive touch-sensitive panel (and the polarizer) allows the use of an inexpensive decorated sheet having optical anisotropy, and decreases the cost. Moreover, the decorated sheet which is printed different designs can be directly visible, since the decorated sheet lies at close to the surface of whole layers. Therefore, a broader choice of design and an effect of the decoration can be improved.

### BRIEF DESCRIPTION OF THE DRAWINGS

FIG. 1 is a side view illustrates a touch display according to an embodiment of the present invention;

FIG. 2 is a side view of a variation of FIG. 1;

FIG. 3 is a side view of an alternative embodiment of FIG. 1;

FIG. 4 is a side view of an another alternative embodiment of FIG. 1;

FIG. 5 is a side view of further another alternative embodiment of FIG. 1;

FIG. 6 is a side view illustrates an antireflection effect in the embodiment according to the present invention;

FIG. 7 is a side view illustrates a principle of the antireflection in FIG. 6;

FIG. 8 is a side view of a comparative example;

FIG. 9 is a side view of a common touch display using a capacitive touch-sensitive panel.

### DETAILED DESCRIPTION OF THE PREFERRED EMBODIMENTS

A vehicle such as an automobile has an instrument panel installed in at a front of an interior of the vehicle. One or more instrumental devices displaying information needed for a driver are installed at the driver side or at the midpoint of the driver side and the passenger side of the instrument panel. Moreover, one or more control panels to control an air-conditioner or an audio device are installed at the midpoint of the driver side and the passenger side of the instrument panel.

Further, a display device including a liquid crystal display is installed in at least one of the controller of the instrumental device and the control panels.

Then, so-called “touch display” is used as at least one of the display device including the liquid crystal display. Here, “touch display” means the liquid crystal display which can be operated by touching images displayed on the surface of the liquid crystal display with a fingertip and so on.

It is assumed that the touch display has the liquid crystal display displaying the images and a capacitive touch-sensitive panel superposed on the surface of the liquid crystal display.

These touch-sensitive panels are either the resistive touch-sensitive panel or the capacitive touch-sensitive panel. In this case, it is assumed that the touch display using the capacitive touch-sensitive panel which is more sensitive than the touch display using the resistive touch-sensitive panel is used. Here, the capacitive touch-sensitive panel senses a change in capacitance occurred when a fingertip and so on being touch or close to the surface. Thus, unlike the resistive touch-sensitive panel, the capacitive touch-sensitive panel has an advantage that there is no need to sense a pressure by a fingertip touching.

Note that, the display device having the liquid crystal display is set in a storage recess for display device made at a housing not shown in the figure, and the housing is fixed to a vehicle body. A concave portion for a sheet formed to fit the decorated sheet flush with the surface of the housing. The concave portion for sheet is assumed to be slightly larger than the storage recess for display device.

Hereinafter, an embodiment according to the present invention will be described with reference to the drawings.

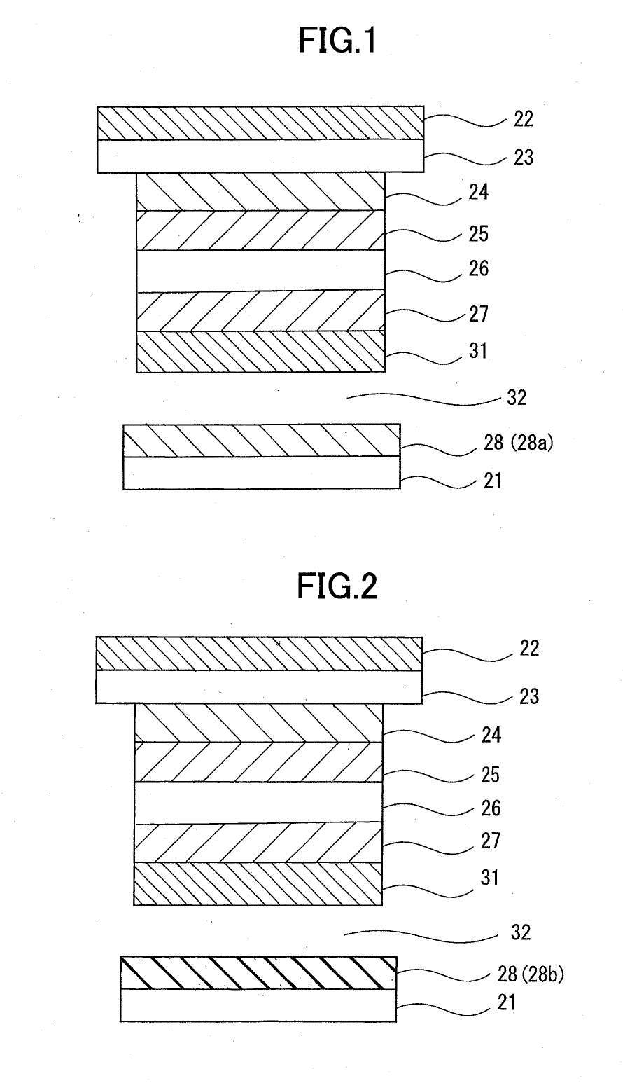

FIGS. 1 to 7 illustrate the embodiment and its variations.

### First Embodiment

### Configuration

Hereinafter, a configuration of the invention will be described.

In this embodiment, the touch display has a following configuration to have a low reflectance of the outside light to suit to be built into a vehicle.

### Configuration 1

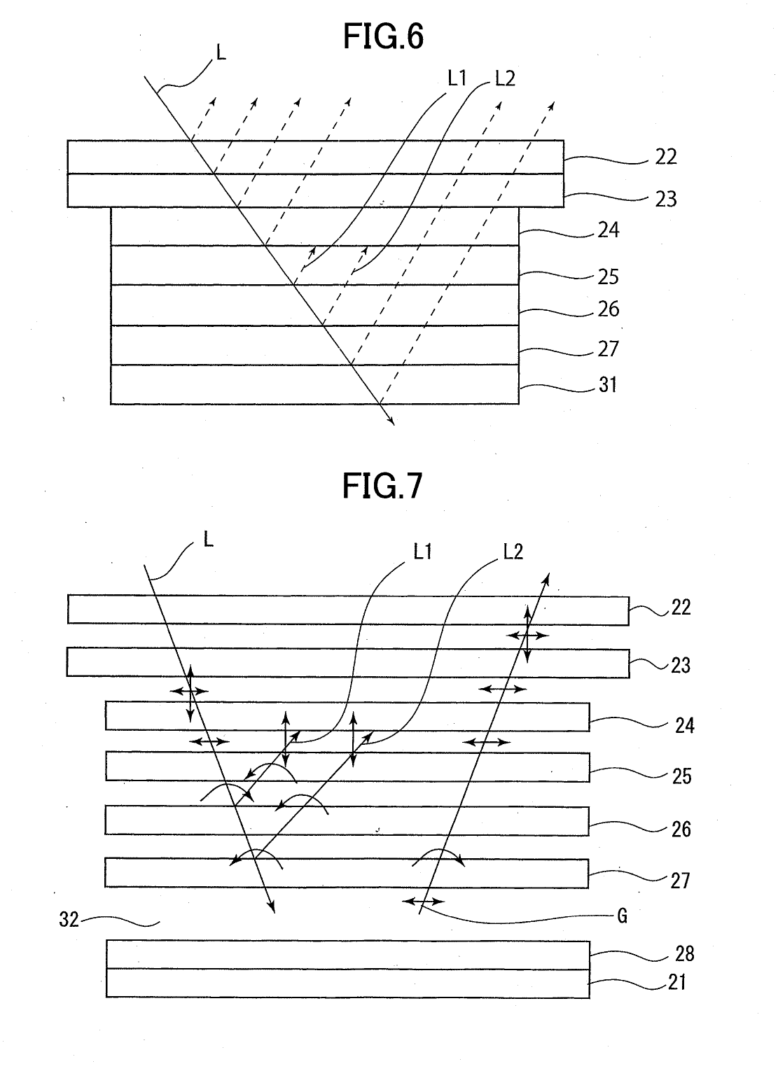

As shown in FIG. 1 or 2, the second quarter-wave plate 27 converting the light passing through into the circular polarization by shifting phase, the capacitive touch-sensitive panel 26, the first quarter-wave plate 25 having the same orientation to the second quarter-wave plate 27, the polarizer 24 converting the light passing through into the linear polarization, the decorated sheet 23 protecting the upper surface of the capacitive touch-sensitive panel 26, and the antireflection layer 22 preventing the surface-reflection of an outside light L (see FIG. 6) are arranged on the liquid crystal display 21 in order from the surface of the liquid crystal display toward the outer surface of the liquid crystal display.

Note that, “the liquid crystal display 21” is assumed to be made of a liquid crystal cell and a backlight covered with a metal casing. A polarizer 28 functioning as the part of liquid crystal display 21 is provided on the liquid crystal cell. The polarizer 28 configures a part of a liquid crystal-shutter to control the image display. The polarizer 28 can be antireflection-finished as illustrated in FIG. 1 (polarizer with antireflection layer 28a), or pearskin-finished as a variation illustrated in FIG. 2 (pearskin-finished polarizer 28b).

“The antireflection layer 22” is assumed to be a resin film which is antireflection-finished and so on. For the antireflection layer 22, for instance, an antireflection film such as an AG (Anti-Glare) film or an AR (Anti-Reflection) film is used. The AG film is a film with a surface asperity formed by adding particles within it, and prevents the reflection by using a scattering caused by the surface asperity and an inner scattering caused by differences of refraction index between the film and the particles. The AR film decreases the reflection by making both reflections from a surface and a rear surface of the film opposite in phase, and annihilating each other. For this purpose, the AR film has a metal-oxide layer on its surface.

“The decorated sheet 23” configures a surface design of the display device. Besides, the decorated sheet 23 has a function to protect the surface and so on. As necessary, various designs are formed on the decorated sheet 23. The decorated sheet 23 is formed into same size as a sheet recess of the casing along with the antireflection layer 22. An inexpensive material having optical anisotropy, for instance polycarbonate, can be used as the decorated sheet 23. Note that, an expensive material having optical isotropy can be naturally used as the decorated sheet 23, although there is no need for.

“The polarizer 24” is an optical film which allows only light having a particular direction of polarization to pass through. The polarizer 24 is arranged in the same orientation of polarization to the polarizer 28 of the liquid crystal display 21.

“The first quarter-wave plate 25” is an optical film which converts the light passing through the polarizer 24 into the circular-polarized light by shifting the phase of the direction of polarization. The first quarter-wave plate 25 also has another function to convert the circular-polarized light into the linearly-polarized light.

“The capacitive touch-sensitive panel 26” is a transparent sensitive panel which senses the change in capacitance when a fingertip and so on are touched or came close to the surface thereof. The capacitive touch-sensitive panel 26 has higher sensitivity than the resistive touch-sensitive panel which senses a pressure of the touch operation.

The capacitive touch-sensitive panel 26 is formed mainly of a material having a hard surface such as glass, and the sensing performance does not lost or decreased if the surface is covered by adhered or coating material thicknesses of up to 1.5 mm. Note that, the sum of thicknesses of the antireflection layer 22, the decorated sheet 23, the polarizer 24, and the first quarter-wave plate 25 is less than around 0.8 mm, therefore the thickness becomes approximately half of the 1.5 mm that the capacitive touch-sensitive panel 26 can sense wherethrough.

“The second quarter-wave plate 27” is arranged in the same direction to the first quarter-wave plate 25. As the second quarter-wave plate 27, a same optical film as the first quarter-wave plate 25 can be used.

Further, the polarizer 24, the first quarter-wave plate 25, the capacitive touch-sensitive panel 26 and the second quarter-wave plate 27 can be formed in same size as the screen of the liquid crystal display 21. Therefore, production costs can be reduced.

Moreover, at least the antireflection layer 22, the decorated sheet 23, the polarizer 24, the first quarter-wave plate 25, and the capacitive touch-sensitive panel 26 are integrated into a surface panel.

Note that, in FIG. 1 and FIG. 2, the second quarter-wave plate 27 and a second antireflection layer 31 are also integrated into the surface panel.

### Configuration 2

The second antireflection layer 31 can be arranged between the second quarter-wave plate 27 and the liquid crystal display 21.

Now, as “the second antireflection layer 31”, same material to the (first) antireflection layer 22 can be used.

Note that, as shown in FIG. 1 and FIG. 2, the antireflection layer 22, the decorated sheet 23, the polarizer 24, the first quarter-wave plate 25, the capacitive touch-sensitive panel 26, and the second quarter-wave plate 27 are integrated by sticking the layers together with adhesive material.

On the other hand, the liquid crystal display 21 is separated from the surface panel formed of the capacitive touch-sensitive panel 26 and others by a layer of air 32.

Now, the term “the capacitive touch-sensitive panel 26 and others” indicates “the surface panel” which is combined layers of the capacitive touch-sensitive panel 26 and adhered or covering layers on the front and the rear side surface thereof. In this case, the surface panel is manufactured by different processes from the liquid crystal display 21 and attached to the liquid crystal display 21 later.

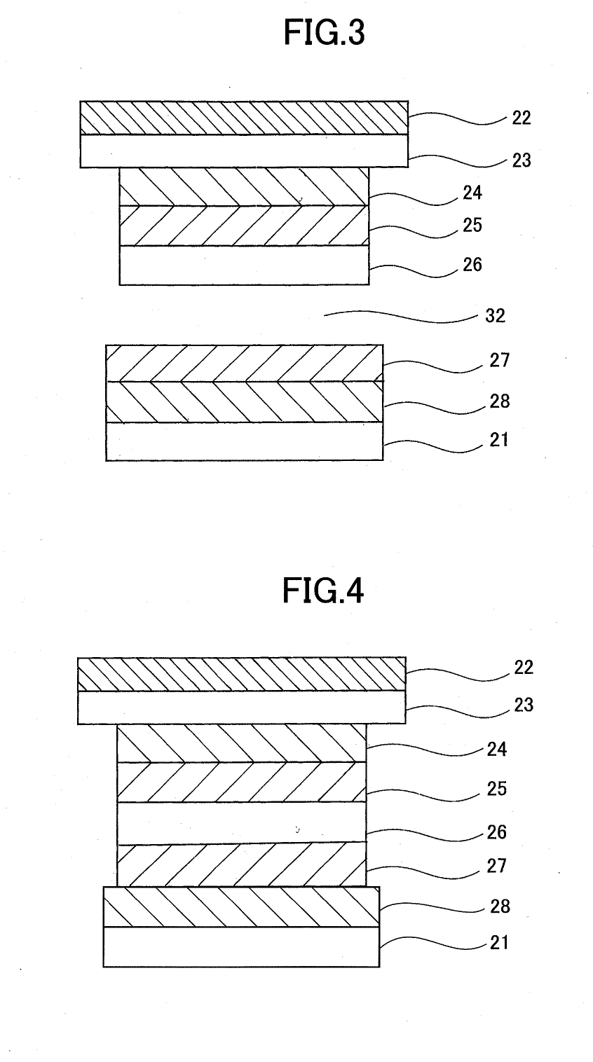

As shown in FIG. 3, the surface panel can be formed without the second antireflection layer 31. In this case, as another embodiment, the second quarter-wave plate 27 is integrated with the liquid crystal display 21 by attaching on the surface of the polarizer 28 of the liquid crystal display 21 instead of a rear surface of the capacitive touch-sensitive panel 26. Therefore, the second quarter-wave plate 27 can produce an effect at the surface of the liquid crystal display 21, and a low reflectance can be obtained as is the case of the surface panel with the second antireflection layer 31.

In this case, the surface panel is formed of the antireflection layer 22, the decorated sheet 23, the polarizer 24, the first quarter-wave plate 25, and the capacitive touch-sensitive panel 26. In addition, the second quarter-wave plate 27 is attached to the liquid crystal display 21 during the manufacturing processes of the liquid crystal display 21 or later as a part of the liquid crystal display 21.

### Configuration 3

As shown in FIG. 4, at least the antireflection layer 22, the decorated sheet 23, the polarizer 24, the first quarter-wave plate 25, the capacitive touch-sensitive panel 26, and the second quarter-wave plate 27 can be directly and integrally attached to the surface of the liquid crystal display 21.

Now, the term “directly and integrally attached” means to integrate the liquid crystal display 21 with the surface panel which is generally separated from the liquid crystal display 21. In other words, the surface panel and the liquid crystal display 21 are integrated by sticking together of their entire surfaces with adhesive material. The surface panel is attached to the liquid crystal display 21 as a part thereof, during the manufacturing processes of the liquid crystal display 21 or later.

In the case shown in the FIG. 4, the second antireflection layer 31 can be provided between the second quarter-wave plate 27 and the liquid crystal display 21.

The polarizer 28 functions as a part of the liquid crystal display 21. Thus, the polarizer 28 can be naturally provided according to the needs of the liquid crystal display 21.

### Configuration 4

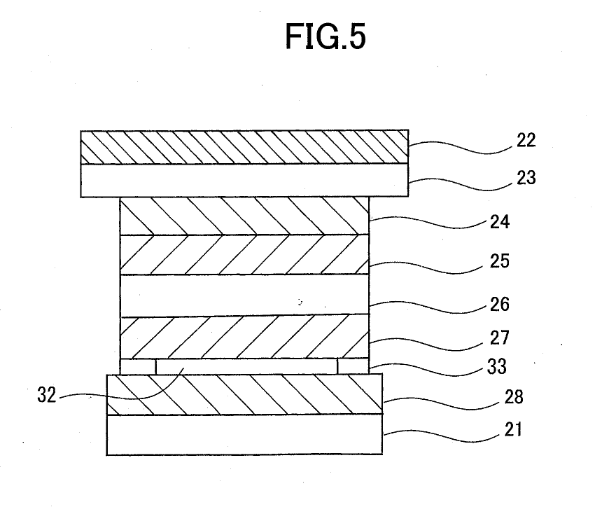

Alternatively, as shown in FIG. 5, at least the antireflection layer 22, the decorated sheet 23, the polarizer 24, the first quarter-wave plate 25, the capacitive touch-sensitive panel 26, and the second quarter-wave plate 27 can be integrally attached to the surface of the liquid crystal display 21 through a spacer 33.

A space thickness of approximately 1 mm is provided between the capacitive touch-sensitive panel 26 and the liquid crystal display 21 to avoid an effect of noise from the liquid crystal display 21. Therefore, the capacitive touch-sensitive panel 26 and others (the surface panel) and the liquid crystal display 21 are adhered each other by the spacer 33 such as a double-faced adhesive tape with a thickness of approximately 1 mm. The spacer 33 is installed at a rim of the surface panel and the liquid crystal display 21. In this case, the surface panel is attached to the liquid crystal display 21 later.

Note that, in the cases of FIGS. 1 to 3, the capacitive touch-sensitive panel 26 and others (the surface panel) and the liquid crystal display 21 are completely separated, and the layer of air 32 separating these two has the thickness of about 1 mm or more. The layer of air 32 is illustrated bigger than in reality in FIGS. 1 to 3.

Further, in the case of FIG. 5, the second antireflection layer 31 can be installed between the second quarter-wave plate 27 and the liquid crystal display 21.

The polarizer 28 functions as a part of the liquid crystal display 21. Thus, the polarizer 28 can be naturally provided according to the needs of the liquid crystal display 21.

Now, advantageous effects of this embodiment will be described.

At first, as shown in FIG. 6, most of the reflection of the outside light L is minimized by the antireflection layer 22 arranged at outermost. At that time, the reflection of the outside light L is highest at the boundary with air. Therefore, the highest effect of antireflection is obtained by arranging the antireflection layer 22 at the outermost part.

Then, a part of the outside light L passing through the antireflection layer 22 is reflected by each layer. Of them, the reflected light L1 from an upper surface of the capacitive touch-sensitive panel 26 and the reflected light L2 from the rear surface of the capacitive touch-sensitive panel 26 will be cut by the polarizer 24. As a result, the reflectance can be minimized to approximately 1% or less.

More particularly, as shown in FIG. 7, the outside light L passing through the antireflection layer 22 and the decorated sheet 23 is unpolarized light. And the outside light L is converted into linearly-polarized light by passing through the polarizer 24. Further, the outside light L, which is now linearly-polarized light, is converted into circularly-polarized light by passing through the first quarter-wave plate 25.

Then, a part of the outside light L, which is the circularly-polarized light, is reflected at the surface of the capacitive touch-sensitive panel 26 and converted into counter-rotating circularly-polarized light by phase-reversal (the reflected light L1). The reflected light L1, which is now the counter-rotating circularly-polarized light, is converted into the linearly-polarized light once again by passing through the first quarter-wave plate 25.

The reflected light L1, which is the linearly-polarized light, is perpendicular to the direction of polarization of the polarizer 24 because of the reversed phase thereof and cut by the polarizer 24.

Moreover, the rest of the outside light L passing through the first quarter-wave plate 25 and became the circularly-polarized light is reflected at the rear surface of the second quarter-wave plate 27 and converted into counter-rotating circularly-polarized light by phase-reversal (the reflected light L2). The reflected light L2, which is now the counter-rotating circularly-polarized light, is converted into the linearly-polarized light once again by passing through the capacitive touch-sensitive panel 26 and the first quarter-wave plate 25.

The reflected light L2, as is the case in above, which is the linearly-polarized light, is perpendicular to the direction of polarization of the polarizer 24 because of the reversed phase thereof and cut by the polarizer 24.

Note that, as shown in FIG. 6, the other reflected lights are minimized by the antireflection layer 22.

On the other hand, as shown in FIG. 7, other polarizer 28 is integrally attached to the surface of the liquid crystal display 21 as a part of a configuration of the liquid crystal display 21 in advance. An image G from the liquid crystal display 21 is converted into the linearly-polarized light by the polarizer 28. Then, the image G, which is the linearly-polarized light, is converted into the circularly-polarized light by passing through the second quarter-wave plate 27, and further converted into the linearly-polarized light by passing through the capacitive touch-sensitive panel 26 and the first quarter-wave plate 25. This linearly-polarized light can pass through the polarizer 24 without problem by aligning its polarizing direction with polarizing axis of the polarizer 24. Therefore, the image G from the liquid crystal display 21 is visible externally through the decorated sheet 23 and the antireflection layer 22.

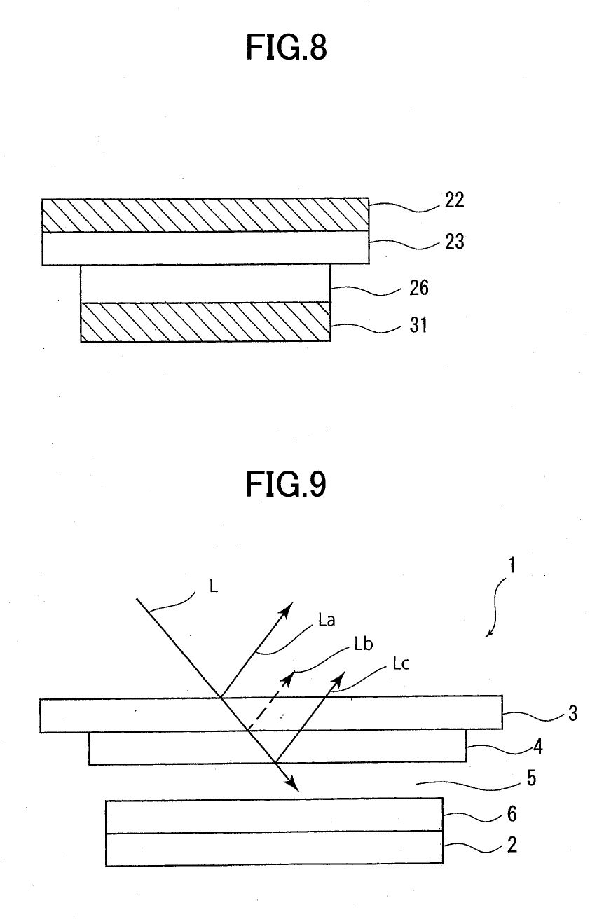

As a comparative example shown in FIG. 8, it could be an antireflective configuration applied to the capacitive touch-sensitive panel 26 and the decorated sheet 23 directly attached together. However, no sufficient result is obtained when this configuration is tested in practice.

More specifically, the comparative example shown in FIG. 8 has a configuration that the capacitive touch-sensitive panel 26 and the decorated sheet 23 attached together, further the antireflection layer 22 is attached to the surface of the decorated sheet 23 and the antireflection layer 31 is attached to the surface of the capacitive touch-sensitive panel 26. In this comparative example, the highest reflectance which is obtained is 2%. The reflectance of 2% means that the reflection of the outside light such as usual sunlight can be reduced well, but it is difficult to reduce the reflection of the outside light such as late afternoon sunlight which is very strong. Therefore, it is considered unfit to apply this configuration to a vehicle.

According to the first embodiment, following effects are achieved.

### Function Effect 1

A following effect is achieved by arranging to the liquid crystal display 21, in order from front side, the antireflection layer 22, the decorated sheet 23, the polarizer 24, the first quarter-wave plate 25, the capacitive touch-sensitive panel 26, and the second quarter-wave plate 27.

More specifically, the decorated sheet 23 can be arranged on the outer side of the capacitive touch-sensitive panel 26 without a decrease in sensing performance by virtue of the fact that the capacitive touch-sensitive panel 26 does not sense a pressure with touch operation. Then, arranging the decorated sheet 23 to the outer side of the capacitive touch-sensitive panel 26 (and the polarizer 24) allows the use of an inexpensive decorated sheet 23 having optical anisotropy, and decreases the cost. Moreover, the decorated sheet 23 which is printed different designs can be directly visible, since the decorated sheet 23 lies at close to the surface of the surface panel. Therefore, a broader choice of design and an effect of the decoration can be improved.

Further, there is only the antireflection layer 22 on the surface of the decorated sheet 23 forming a surface design of the display device. Thus, a difference in level between the surface of the casing and the decorated sheet 23 can be reduced when the decorated sheet 23 is attached to the surface of the casing.

### Function Effect 2

Then, the second antireflection layer 31 is arranged between the second quarter-wave plate 27 and the liquid crystal display 21. Therefore, when the second quarter-wave plate 27 and the liquid crystal display 21 are separated by the layer of air 32, the second antireflection layer 31 reduces the reflection from the layer of air 32, and an antireflection effect can be improved.

### Function Effect 3

Further, at least the antireflection layer 22, the decorated sheet 23, the polarizer 24, the first quarter-wave plate 25, the capacitive touch-sensitive panel 26, and the second quarter-wave plate 27 are directly and integrally attached to the surface of the liquid crystal display 21. Therefore, due to the fact that the layer of air 32 between the second quarter-wave plate 27 and the liquid crystal display 21 is almost none, the reflection from the layer of air 32 can be eliminated and the reflectance can be minimized. And, since the antireflection layer 22, the decorated sheet 23, the polarizer 24, the first quarter-wave plate 25, the capacitive touch-sensitive panel 26, and the second quarter-wave plate 27 are integrated with the liquid crystal display 21, these layers become easy to handle on the whole.

### Function Effect 4

Moreover, at least the antireflection layer 22, the decorated sheet 23, the polarizer 24, the first quarter-wave plate 25, the capacitive touch-sensitive panel 26, and the second quarter-wave plate 27 are attached to the surface of the liquid crystal display 21 through the spacer 33. Thus, the second quarter-wave plate 27 and the liquid crystal display 21 are separated by the layer of air 32 having the thickness of the spacer 33. Therefore, the effect of noise from the liquid crystal display 21 can be avoided, in addition to Function effect 3.

Although the present invention has been described in terms of exemplary embodiments, it is not limited thereto. It should be appreciated that variations may be made in the embodiments described by persons skilled in the art without departing from the scope of the present invention as defined by the following claims.

What is claimed is:

1. A touch display capable of input operation in reaction to a displayed image comprising:
a liquid crystal display displaying images on its surface and a capacitive touch-sensitive panel superposed on a surface of the liquid crystal display; wherein
a second quarter-wave plate converting a light passing through into a circular polarization by shifting phase;
a capacitive touch-sensitive panel;
a first quarter-wave plate having a same orientation to the second quarter-wave plate;
a polarizer converting the light passing through into a linear polarization;
a decorated sheet protecting an upper surface of the capacitive touch-sensitive panel; and
an antireflection layer preventing a surface-reflection of an outside light;
are arranged on the liquid crystal display in order from the surface of the liquid crystal display toward an outer surface of the liquid crystal display.

2. The touch display according to claim 1, further comprising;
a second antireflection layer installed between the second quarter-wave plate and the liquid crystal display.

3. The touch display according to claim 1, wherein the antireflection layer, the decorated sheet, the polarizer, the first quarter-wave plate, the capacitive touch-sensitive panel, and the second quarter-wave plate are directly and integrally attached to the surface of the liquid crystal display.

4. The touch display according to claim 2, wherein the antireflection layer, the decorated sheet, the polarizer, the first quarter-wave plate, the capacitive touch-sensitive panel, and the second quarter-wave plate are directly and integrally attached to the surface of the liquid crystal display.

5. The touch display according to claim 1, wherein the antireflection layer, the decorated sheet, the polarizer, the first quarter-wave plate, the capacitive touch-sensitive panel, and the second quarter-wave plate are attached to the surface of the liquid crystal display through a spacer.

6. The touch display according to claim 2, wherein the antireflection layer, the decorated sheet, the polarizer, the first quarter-wave plate, the capacitive touch-sensitive panel, and the second quarter-wave plate are attached to the surface of the liquid crystal display through a spacer.
